(19) United States
(12) Patent Application Publication
(10) Pub. No.: US 2010/0013851 A1
(43) Pub. Date: Jan. 21, 2010

(54) COLOR CONVERSION SYSTEM USING A THREE DIMENSIONAL LOOK UP TABLE WITH SUB-CUBE CURVATURE MODELING

(76) Inventors: Cary A. Shoup, Wichita, KS (US); Kenbe D. Goertzen, Topeka, KS (US)

Correspondence Address: KAREN A. REX, 950 Gemini, Suite 6, HOUSTON, TX, 77058, US

(21) Appl. No.: 12/504,391

(22) Filed: Jul. 16, 2009

Related U.S. Application Data
(60) Provisional application No. 61/081,476, filed on Jul. 17, 2008.

(51) Int. Cl. G09G 5/02; G06F 15/16

(52) U.S. Cl. 345/591; 345/502

(57) ABSTRACT

The present invention relates to a color processing device and method by implementation of a color cube function to perform complex conversion from one color space to another. Color processing in real-time with a finite amount of system resources is achieved by means of a subcube curvature model. A known target space is calculated relative to an original space into final values; the final values are arranged and indexed as a three-output function of three inputs creating a subcube curvature model. The subcube curvature model is represented, communicated and stored in a reproducible way wherein each subcube curvature model is processed and displayed in substantially real-time. The color processing device is a system capable of translating one color space to another in real-time in finite resource systems, the system utilizing color processing hardware including a parallel processor, a field programmable gate array semiconductor; and phase-multiplexed look-up table arrangement with SRAM.

The present application claims the benefit of prior filed U.S. Provisional Patent Application, Ser. No. 61/081,476 filed 17 Jul. 2008, to which the present application is a regular U.S. national application.

### FIELD OF THE INVENTION

The present invention is in the field of apparatuses for and methods of color processing. More specifically, the present invention relates to a color processing device and method by implementation of a color cube function to perform complex conversion from one color space to another.

### BACKGROUND OF THE INVENTION

A video server needs the ability to speak common languages on all interfaces. Color representation is no exception, and had historically been a real challenge for video system engineers working with various capture, edit and preview devices. The challenge stems from fundamentally different technologies being used together to produce an ultimately artistic, but tightly specified result. Wide content distribution further complicates matters because of the numerous options in viewing technology and venue.

The centralized role of a video server mandates conversion between record, storage and playback color representations. Current video products will typically interface with other equipment in standardized color spaces. However, those standardized color spaces do not apply during content production and intermediate processing. This further complicates the transmission and viewing of material during production and post-production overflows. This need for a general purpose solution gave rise to the present invention.

Color cube implementations have become popular for format conversion and for digital film production. By using a three-dimensional (i.e. X by Y by Z) cube as a straight lookup table, virtually any three-component color space can be manipulated or transformed into another three-component space.

The present invention provides a means to translate from one color space to another in real-time, with utilization of a finite amount of system resources and further addresses the issues of minimizing storage representation and maintaining output precision while increasing output accuracy by adding subcube curvature to the process model. The result allows systems with finite (practical) resources to calculate a highly-accurate estimation of values between the stored cube points (vertices, which otherwise only represent a tiny fraction of possible outputs). Cube storage requirements are also minimized, which allows for new cube characteristics to be stored, loaded, or transmitted quickly without an inefficient overhead.

### SUMMARY OF THE INVENTION

The present invention is a color processing system providing a means translate from one color space to another color space in real time, with a finite amount of system resources using a sub-cube curvature process model. More specifically, the present system uses a three-dimensional cube as a straight lookup table. This allows for virtually any three-component color space to be manipulated or transformed into another three-component space.

A translation cube is created (calculated) by knowing the target space relative to the original space and performing all required mathematical steps to get from one to the other. Once the final values are calculated, they are properly arranged and indexed as a three-output function of three inputs.

The cube is then represented, communicated and stored in a reproducible way. Various formats, including data files, original equations or a compressed-data representation may be used.

The cube is then implemented and used as a lookup system. A source index is calculated and the final answer found by resolving the index.

The color processing device is a system capable of translating one color space to another in real-time in finite resource systems, the system utilizing color processing hardware including a parallel processor, a field programmable gate array semiconductor; and phase-multiplexed look-up table arrangement with SRAM.

### BRIEF DESCRIPTION OF THE DRAWINGS

FIG. 1 is a perspective view of a representation of the color cube and related subcubes.

FIG. 2 is a typical curvature calculation with a parabolic model.

FIG. 3 is a typical curvature calculation with exponential model.

FIG. 4 is a diagram showing the general relationship between a source cube and its target cube.

FIG. 5 is a diagram showing the source cube data format.

FIG. 6 is a diagram showing the target cube data format.

FIG. 7 is diagram showing the color process model for applying curvature information along side linear interpolation.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

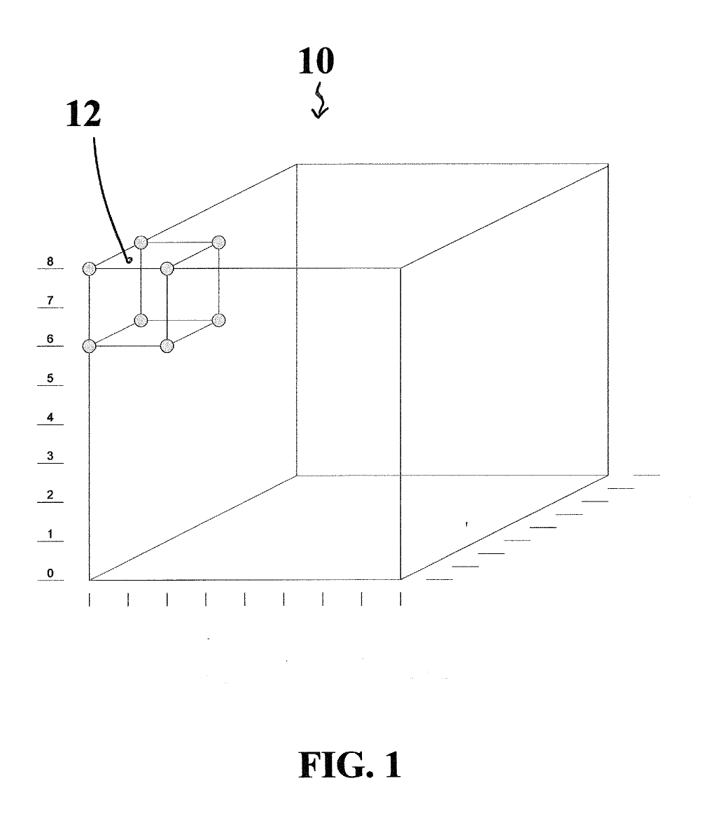

In implementing the subcube curvature model, a standard three-dimensional lookup is used to resolve the eight nearest neighbor vertices within the cube, limited finite resolution provided by the stored cube. As shown in FIG. 1, these vertices bound a subcube, in which values must be estimated between the eight available corners. Trilinear interpolation provides this baseline estimate. An additional curvature factor is then applied to describe the deviation of the actual target value from the lineally estimated value. This final result is calculated from the linear estimate plus the curvature factor.

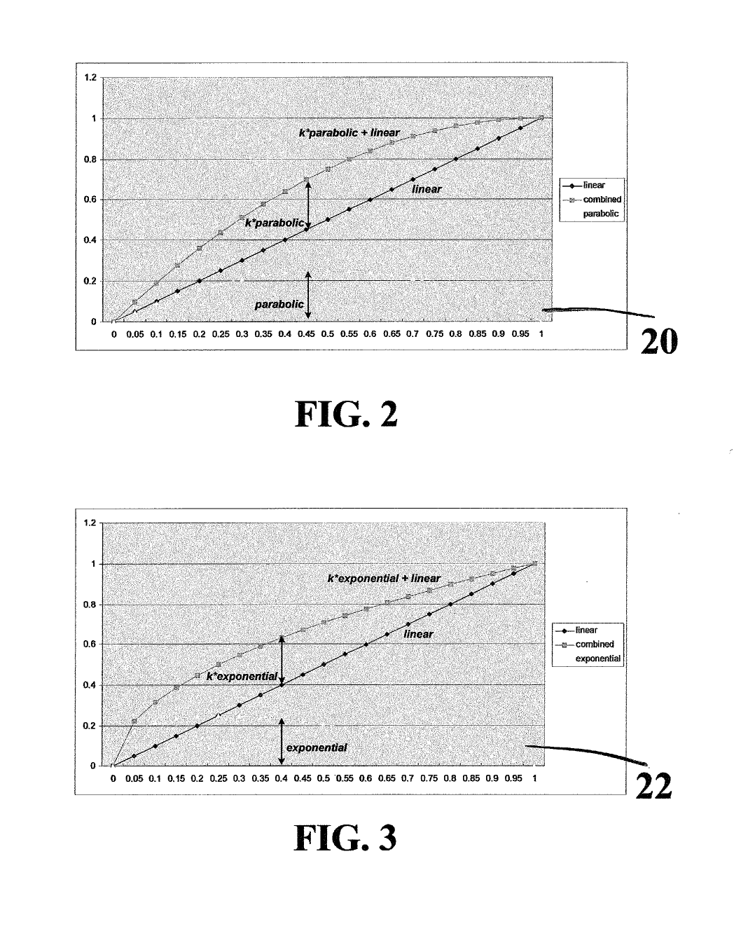

Multiple curvature models may be used at the cost of cube size and system resources. Typical curvature model which are employed include the parabolic 20, FIG. 2:

0.25−|d−0.5|²

and exponential 22, FIG.3:

d^{1/2}−d

where d represents the distance from one edge of the subcube to the other in a given dimension, normalized to [0 . . . 1].

One implementation well-suited to real-time processing resources is to represent the base curvature model with a lookup table (to avoid implementing difficult functions) and then to vary the amplitude of that curvature with a multiplier. For example, the multiplied parabolic curvature result would be:

k*(0.25−|d−0.5|²)

Where the multiplier, k, is precalculated per subcube to provide the optimal result for that subcube. This allows the more complex parabolic function to be modeled in a finite lookup table. Furthermore, the curvature model to be used (parabolic lookup in this case) can be designated by a small field (single or multiple bits per subcube) which serves to select which of the predefined parabolic, logarithmic, or other models to apply for a particular component in a particular subcube.

Precalculating this cube of vertices and subcube curvature information turns out to be a challenge similar to the processing itself. In the present invention, a target cube is created. The target cube addresses multiple issues, including that of a minimized storage implementation, and an efficiency-optimized mathematical model of the intentional color transformation.

In a preferred embodiment, a target cube 12 is calculated from the source cube 10. The target cube 12 is a direct implementation model for a real-time (or time optimized) processing system.

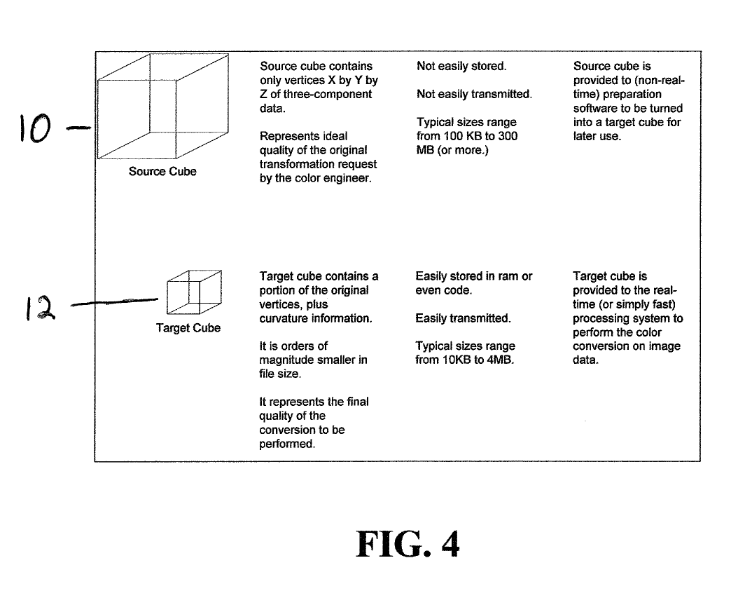

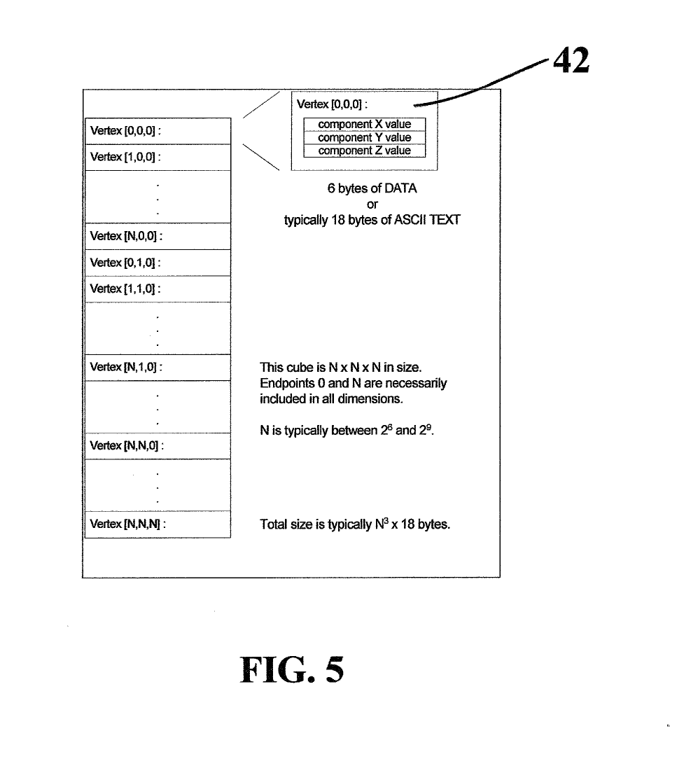

FIG. 4 shows the general relationship between a source cube 10 and its target cube 12. The color transform designer provides a source cube, see FIG. 5, which is a high resolution three dimensional look up table (LUT) 42. The resolution is only limited by the storage and transmission mediums associated with a device, and should be large enough to represent any interesting facets (especially nonlinearities) of the overall color transformation.

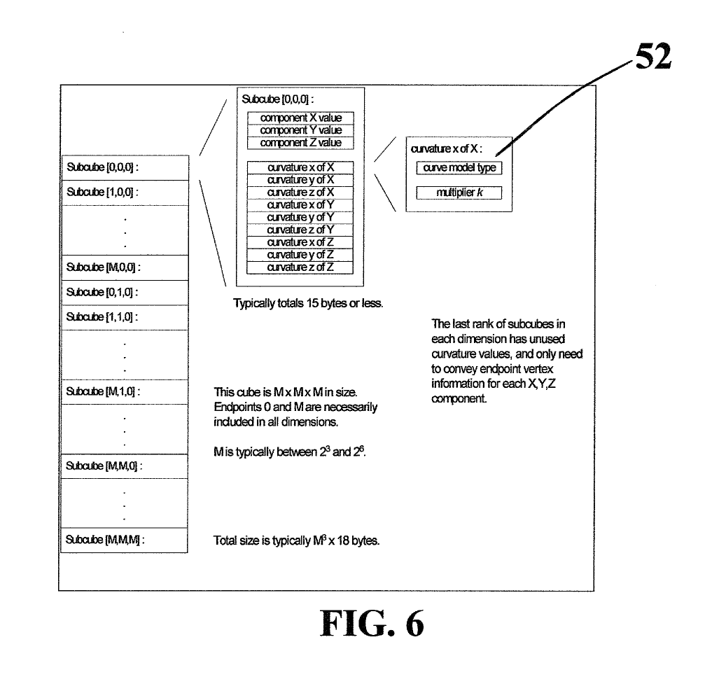

This larger source cube is then parsed and used to calculate the target cube. As shown in FIG. 6, the target cube is a smaller representation, and stores only a limited number of vertices. Additionally, it stores information per subcube which includes (per component) the curvature model (parabolic v. logarithmic v. otherwise) and the multiplier k, where k includes sign and magnitude 52. This provides for the type of interpolation to be represented in the subcube data alongside the curvature information, allowing for more overall flexibility.

The target cube 12 is the direct implementation model for a real-time (or time optimized) processing system. The target cube 12 represents the complete accuracy of a transformation. This allows for a scalable approach to color processing because the target cube resolution can be varied to meet the application demand. High-quality systems can allocate more storage resources to the target cube resolution, whereas systems with less of a quality instrument can save resources (cost/space/power) for an optimum application.

Once the target cubes are created, defining “presets” for example, the cubes are ideally sized for long-term storage and loading on demand. A simple binary file/image will fully represent a target cube, and will require only a few minimal header definitions for resolution, curvature descriptors and other parameters.

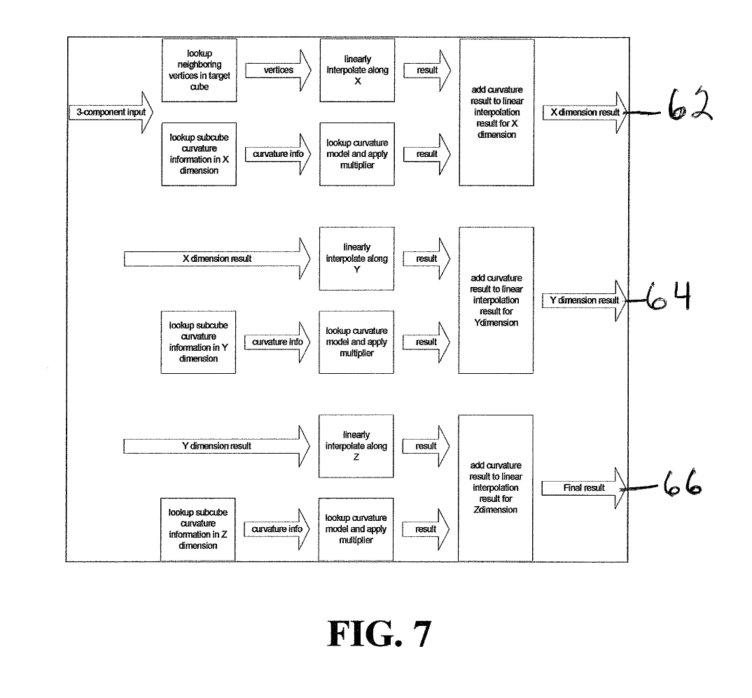

During operation, the target cube 12 is selected and the lookup process is applied as stated above. The target subcube is identified and the boundaries used to determine a trilinear interpolation baseline per component. The curvature information is added per component to provide the final results: X dimension result 62, Y dimension result 64 and Final result 66. See FIG. 7.

This allows for time-sensitive or resource-sensitive processing of color transformations with a wide range of required accuracy and a wide range of mathematical complexity.

The system is designed to accommodate real-time operation in finite-resource systems, including an FPGA-based solution to the process, in which SRAM is a very limited commodity, and process-time must be limited to allow for a pixel-lookup-result per one or two clock cycles in real-time. Parallel processing is a requirement.

The color processing hardware utilizes a phase-multiplexed lookup table arrangement, in which SRAM elements have been allocated so as to provide all eight nearest-neighbor vertex lookups in a single clock cycle, regardless of position, and without prefetch-and-cache operation of any sort. This allows for very efficient utilization of embedded SRAM resources, while preserving the ability to function faster than real-time.

In another embodiment of this system hardware, dual stream processing allows the real-time ability to process multi-stream color conversion simultaneously referenced against the same target cube. This is important because it cuts the total target cube storage requirement in half (or more) for resource-limited hardware.

The typical sizes used in this document are intended to give a sense of scale for today's technology (2008). Future levels of technology may provide drastic changes in data representation, but the invention itself will scale appropriately in relative usefulness with the general advancement of technology.

While the above description contains many specifics, these should not be construed as limitations on the scope of the invention, but rather as exemplifications of one or another preferred embodiment thereof. Many other variations are possible, which would be obvious to one skilled in the art.

For example, this invention is not limited to transformations in three-dimensional space. N-dimension adaptations will allow more complex data transformations (likely something other than color) to be efficiently calculated from a lookup-table-driven source.

Accordingly, the scope of the invention should be determined by the scope of the appended claims and their equivalents, and not just by the embodiments.

What is claimed is:

1. A method for color processing a first color space to a second color space in substantially real-time to a format compatible with a display device by means of a subcube curvature model, the method comprising:
calculating a known target space relative to an original source space into final values;
arranging and indexing the final values as a three-output function of three inputs creating a subcube curvature model; and
representing, communicating and storing the subcube curvature model in a reproducible way;
wherein each subcube curvature model is processed and displayed in substantially real-time.

2. The method for color processing of claim 1, whereby the known target space relative to the original source space is calculated by representing the base curvature model with a lookup table followed by varying the amplitude of the calculated curvature with a multiplier.

3. A color processing system capable of translating one color space to another in real-time in finite resource systems, the system comprising color processing hardware:
parallel processor;
a field programmable gate array semiconductor; and
phase-multiplexed look-up table arrangement with SRAM.

4. The color processing system of claim 3, wherein the phase-multiplexed look-up table arrangement SRAM elements are allocated to provide eight nearest-neighbor vertex lookups in a single clock cycle, regardless of position, and without prefetch-and-cache operation of any sort.
